(19) United States
(12) Patent Application Publication
(10) Pub. No.: US 2013/0222207 A1
(43) Pub. Date: Aug. 29, 2013

(54) FLEXIBLE TERMINAL AND METHOD FOR PROVIDING A CONTINUOUS SCREEN OF FLEXIBLE DISPLAY USING THE SAME

(71) Applicant: Pantech Co., Ltd., (US)

(72) Inventor: Kyun-Young BAEK, Seoul (KR)

(73) Assignee: Pantech Co., Ltd., Seoul (KR)

(21) Appl. No.: 13/739,307

(22) Filed: Jan. 11, 2013

(30) Foreign Application Priority Data
Feb. 29, 2012 (KR) 10-2012-0021454

(51) Int. Cl. G06F 5/00

(52) U.S. Cl. CPC G06F 5/00
USPC 345/1.1

(57) ABSTRACT

A terminal includes a flexible display including a first screen and a second screen on which images are displayed, the first screen and second screen being disposed on opposite sides of the flexible display, and a control unit to calculate an overlapping region of the second screen, to map coordinates of the first screen to the second screen with respect to the overlapping region, and to display a portion of the image on the second screen, in which the overlapping region of the second screen overlaps at least a portion of the first screen

### CROSS-REFERENCE TO RELATED APPLICATION

This application claims priority from and the benefit under 35 U.S.C. §119(a) of Korean Patent Application No. 10-2012-0021454, filed on Feb. 29, 2012, which is hereby incorporated herein by reference for all purposes.

### BACKGROUND

1. Field

The following description relates to a flexible display and a method for displaying a continuous image on a folded screen.

2. Discussion of the Background

A flexible display is formed of a flexible material, such as plastic instead of glass, such that the flexible display may be bent, folded, or rolled up without damaging the flexible display.

The use of the flexible display in various environments may be increased due, at least in part, to the malleable nature of the flexible display. Further, a study has been conducted to determine whether the flexible display is able to provide an input signal by folding the flexible display.

In a related art, both a front surface and a rear surface of the flexible display are used as a display, however, a method for inputting a signal and a method for maintaining a continuity of an image displayed on the flexible display in a state where the flexible display is folded is not described in the related art.

### SUMMARY

Exemplary embodiments of the present invention provide a flexible display and a method for displaying a continuous image on a folded screen.

Additional features of the invention will be set forth in the description which follows, and in part will be apparent from the description, or may be learned by practice of the invention.

Exemplary embodiments of the present invention provide a method for continuously displaying an image on a flexible display including displaying an image on a first screen of the flexible display, the flexible display including the first screen and a second screen; calculating an overlapping region of the second screen, the overlapping region of the second screen overlapping at least a portion of the first screen; mapping coordinates of the first screen with the second screen for the overlapping region; and displaying at least a portion of the image displayed on the first screen on the overlapping region of the second screen based on the mapped coordinates.

Exemplary embodiments of the present invention provide a terminal including a flexible display including a first screen and a second screen on which images are displayed, the first screen and second screen being disposed on opposite sides of the flexible display; and a control unit to calculate an overlapping region of the second screen, to map coordinates of the first screen to the second screen with respect to the overlapping region, and to display a portion of the image on the second screen, in which the overlapping region of the second screen overlaps at least a portion of the first screen.

Exemplary embodiments of the present invention provide a terminal including a flexible display including a first screen and a second screen to display an image on the first screen; a pressure detecting unit including a plurality of pressure detectors to detect a change in pressure applied to at least one of the pressure detectors; a sensing unit to determine a folded direction and a folded region of the flexible display based on the detected change in pressure; and a control unit to calculate a region where the first screen and the second screen overlap based on the folded direction and the folded region, to map coordinates of the overlapped first screen to the second screen, and to display a portion of the image on the second screen.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic configuration diagram illustrating a terminal with a flexible display according to an exemplary embodiment of the present invention.

FIG. 2 is a plan view illustrating the terminal of FIG. 1.

FIG. 3 is a diagram illustrating a method for calculating an overlapping region of a first screen and a second screen when a flexible display is folded according to an exemplary embodiment of the present invention.

FIG. 4a and FIG. 4b are diagrams illustrating a method for calculating an overlapping surface of a first screen and a second screen when a flexible display of is folded at an angle according to an exemplary embodiment of the present invention.

FIG. 5 is a schematic configuration diagram illustrating a terminal with a flexible display according to an exemplary embodiment of the present invention.

FIG. 6 is a plan view illustrating the terminal of FIG. 5.

FIG. 7 is a cross-sectional view illustrating the pressure detector of FIG. 6.

FIG. 8 is a diagram illustrating a detection of a folding point on a flexible display according to an exemplary embodiment of the present invention.

FIG. 9a and FIG. 9b are diagrams illustrating a method for calculating an overlapping surface of a first screen and a second screen when a flexible display is folded at an angle according to an exemplary embodiment of the present invention.

FIG. 10 is a schematic configuration diagram illustrating a terminal with a flexible display according to an exemplary embodiment of the present invention.

FIG. 11 is a plan view illustrating the flexible terminal of FIG. 10.

FIG. 12 is a diagram illustrating a method for calculating an overlapping region of a first screen and a second screen when a flexible display is folded at an angle according to an exemplary embodiment of the present invention.

FIG. 13 is a plan view illustrating a flexible display of terminal of FIG. 10.

FIG. 14 is a diagram illustrating a method for calculating an overlapping region of a first screen and a second screen when a flexible display is folded at an angle according to an exemplary embodiment of the present invention.

FIG. 15 is a diagram illustrating a movement of an image from a first screen to a second screen on a flexible display according to an exemplary embodiment of the present invention.

FIG. 16 is a flowchart illustrating a method for providing a continuous image on a flexible display according to an exemplary embodiment of the present invention.

FIG. 17 is a flowchart illustrating a method for providing a continuous image of a flexible display according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

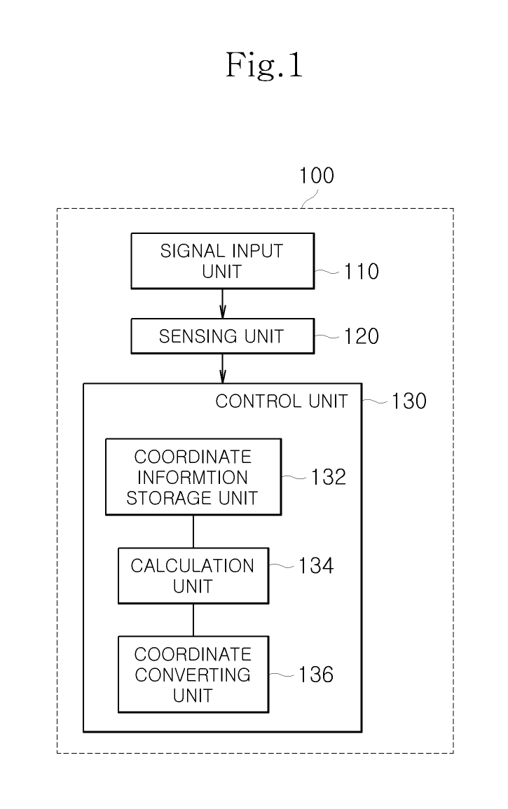

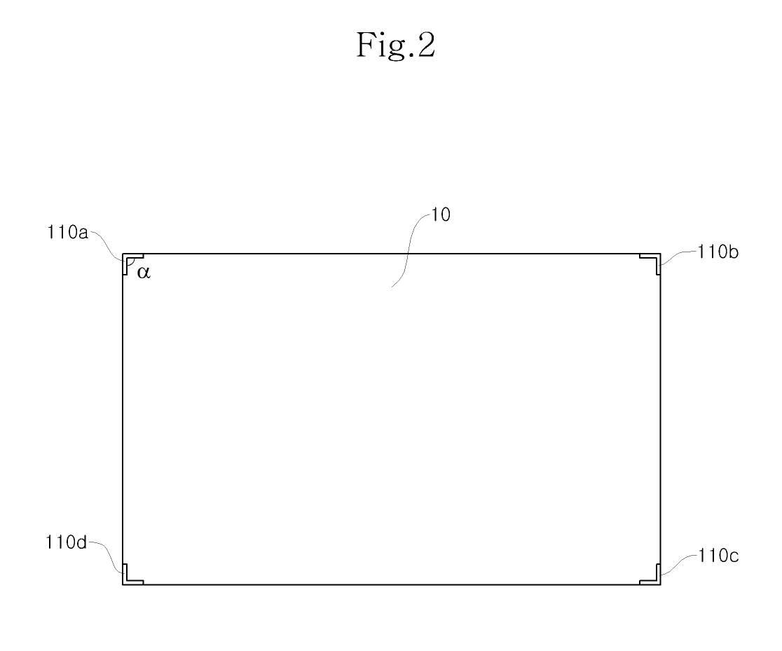

FIG. 1 is a schematic configuration diagram illustrating a terminal with a flexible display according to an exemplary embodiment of the present invention. FIG. 2 is a plan view illustrating the terminal of FIG. 1.

Referring to FIG. 1 and FIG. 2, a mobile terminal 100 includes a signal input unit 110, a sensing unit 120, and a control unit 130. The signal input unit 110 includes a first signal input device 110a, a second signal input device 110b, a third signal input device 110c, and a fourth signal input device 110d.

Each of the first signal input device 110a, the second signal input device 110b, the third signal input device 110c, and the fourth signal input device 110d is disposed in a region where a vertex of outer edges of the flexible display 10 or a corner of the flexible display 10 is positioned, and may be formed to extend along both edges about the vertex. A corner angle α of the flexible display 10 is formed between adjacent edges of the flexible display 10 or at a first corner of the flexible display 10. The corner angle α may be 90° in FIG. 2. The other corner angles include angles formed between the other adjacent edges of the flexible display 10 and correspond to the second signal input device 110b, the third signal input device 110c, and the fourth signal input device 110d, i.e., a second angle, a third angle, and a fourth angle. At least one of the second angle, the third angle, and the fourth angle may have similar or the same angle as the corner angle α. Accordingly, the signal input devices, including the first signal input device 110a, the second signal input device 110b, the third signal input device 110c, and the fourth signal input device 110d may be disposed along the four corners of the flexible display 10 and may substantially be formed to have a right angle shape or have 90° between the two edges forming the respective angle. However, aspects of the invention are not limited thereto, such that the shapes of the signal input devices, including the first signal input device 110a, the second signal input device 110b, the third signal input device 110c, and the fourth signal input device 110d may be different with a change in the corner angle α of the flexible display 10.

The sensing unit 120 may detect a position where at least one of the signal input devices, including the first signal input device 110a, the second signal input device 110b, the third signal input device 110c, and the fourth signal input device 110d, contact or overlap the first screen or the second screen of the flexible display 10. To continuously display a portion of an image or information, which may be displayed on a first screen of the flexible display 10, may be displayed on a second screen when the flexible display 10 is folded. The flexible display 10 includes the first screen formed or disposed on a first side of the flexible display 10 and the second screen formed or disposed on a second or opposite side of the flexible display 10. More specifically, the image that is or was displayed on the overlapped region of the first screen may be displayed on the overlapping region of the second screen, the overlapping region corresponding to a position where the signal input devices, including the first signal input device 110a, the second signal input device 110b, the third signal input device 110c, and the fourth signal input device 110d, contact or overlap the first screen of the flexible display 10 using the sensing unit 120. Accordingly, the plurality of signal input devices may calculate one or more overlapping regions of the first screen and the second screen.

At least one of the signal input devices, including the first signal input device 110a, the second signal input device 110b, the third signal input device 110c, and the fourth signal input device 110d may be formed of a conductor with a specific dielectric constant. Accordingly, the sensing unit 120 may determine whether an object contacting or overlapping the first screen is one of the first signal input device 110a, the second signal input device 110b, the third signal input device 110c, and the fourth signal input device 110d. More specifically, when a conductor with a specific dielectric constant contacts or overlaps the first screen, a specific change in the current may occur at the contacted or overlapped position, such that the sensing unit 120 may determine that the contact or the overlap is associated with one of the first signal input device 110a, the second signal input device 110b, the third signal input device 110c, and the fourth signal input device 110d. The method for calculating the overlapping region of the first screen and the second screen will be described in more detail later.

The control unit 130 may calculate a region where the first screen of the flexible display 10 overlaps the second screen based on the position of at least one of the first signal input device 110a, the second signal input device 110b, the third signal input device 110c, and the fourth signal input device 110d, which may be detected by the sensing unit 120. Further, the control unit 130 may allow coordinates of the first screen to be mapped to coordinates of the second screen in the overlapping region based on the position of at least one of the first signal input device 110a, the second signal input device 110b, the third signal input device 110c, and the fourth signal input device 110d. Accordingly, the control unit 130 may display a portion of the image that is or was displayed on the overlapped region of the first screen on the second screen, thereby continuously displaying the image on the first screen and the overlapping second screen. The first screen may, without limitation, refer to a screen on which the current image may be displayed. The second screen may, without limitation, may refer to a rear surface of the first screen. The flexible display 10 may not display an image on the second screen when the flexible display 10 is not folded, bent, rolled or adjusted by a user, but aspects need not be limited thereto.

Referring again to FIG. 1, the control unit 130 includes a coordinate information storage unit 132, a calculation unit 134, and a coordinate converting unit 136.

The coordinate information storage unit 132 may store the positional coordinate value of one or more pixels displayed on at least one of the first screen and the second screen of the flexible display 10. The coordinate information storage unit 132 may store shape information of at least one of the first signal input device 110a, the second signal input device 110b, the third signal input device 110c, and the fourth signal input device 110d. As the coordinate information storage unit 132, an external storage device, which may semi-permanently store data, or a nonvolatile memory, such as a read-only memory (ROM) or a Not And electronic logic gate (NAND) flash memory, may be used. The positional coordinate value may refer to, without limitation, a position, a point referring to a specific location, a coordinate, or information associated thereto.

The calculation unit 134 may calculate the overlapping region of the first screen and the second screen based on the position value of at least one of the first signal input device 110a, the second signal input device 110b, the third signal input device 110c, and the fourth signal input device 110d, which may be detected by the sensing unit 120.

The coordinate converting unit 136 may allow the coordinates corresponding to the detected positions on the first screen to be mapped to coordinates on the second screen in at least in the overlapping region of the first screen and the second screen. The coordinates of the first screen may be mapped to the coordinates of the second screen based on the positional coordinate values of the first screen and the second screen stored in the coordinate information storage unit 132 and the overlapping region information of the first screen and the second screen calculated by the calculation unit 134. Accordingly, the image that is or was displayed on the overlapped region of the first screen, which may be physically overlapped by the second screen, may be seen on the second screen. More specifically, if the flexible display 10 is folded or bent such that a region of the first screen is overlapped by a rear surface of the first screen, or the second screen, a portion of the image that is or was displayed on the overlapped region of the first screen may be displayed on the second screen to display a continuous image, or an image that is continuous across the first screen and the second screen. Accordingly, a portion of an image may be displayed on the first screen and a corresponding portion of the image may be displayed on the second screen when the flexible display 10 is folded or bent. The corresponding portion of the image may be a portion of the image displayed on the first screen at an area of the front screen in front of which the second screen is disposed, folded, or bent.

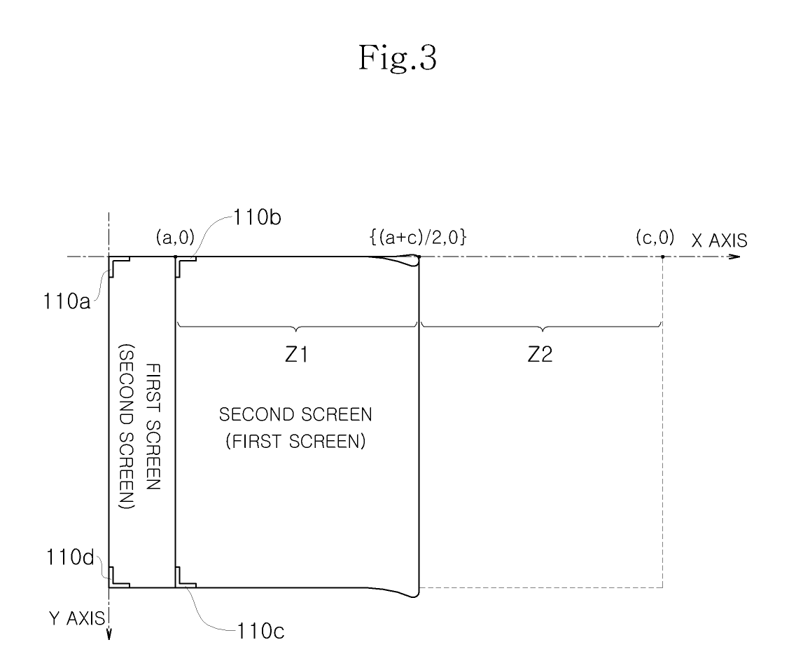

FIG. 3 is a diagram illustrating a method for calculating an overlapping surface of a first screen and a second screen when a flexible display of FIG. 2 is folded. The positions of the first screen may be changed from a laid out, planar, or non-overlapped state to a folded state, such that a rear surface of the first screen or the second screen is overlapped over a portion of the first screen as illustrated in FIG. 3.

More specifically, referring to FIG. 3, the second screen of the flexible display 10 is illustrated as being folded or bent in a rectangular shape over the first screen to overlap a portion of the first screen. Here, the second signal input device 110b and the third signal input device 110c may be detected on the first screen, and coordinate (a, 0) corresponds to the vertex of the signal input devices detected by the sensing unit 120. However, aspects of the invention are not limited thereto, such that other coordinates corresponding to various portions of the third signal input device 110c may be detected. Since the coordinate information storage unit 132 stores the positional coordinate values of the first screen and the second screen and the shape information of at least one of the second signal input device 110b and the third signal input device 110c, the calculation unit 134 may determine that the second screen is folded at a right angle, i.e., a folded portion of the flexible display 10 extends at a right angle with respect to an edge of the flexible display 10, to overlap the first screen based on the coordinates of the detected positions of the second signal input device 110b and the third signal input device 110c detected by the sensing unit 120. Further, since folded length Z2 and folded length Z1 are equal to each other, the calculation unit 134 may calculate coordinate ((a+c)/2, 0) of the folded portion by using this relationship. Accordingly, the calculation unit 134 may calculate the overlapping region of the first screen and the second screen.

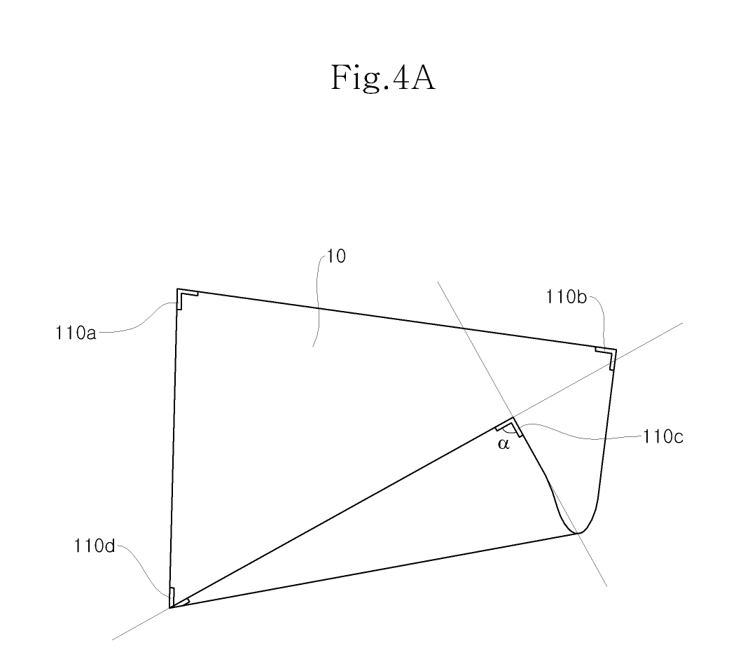

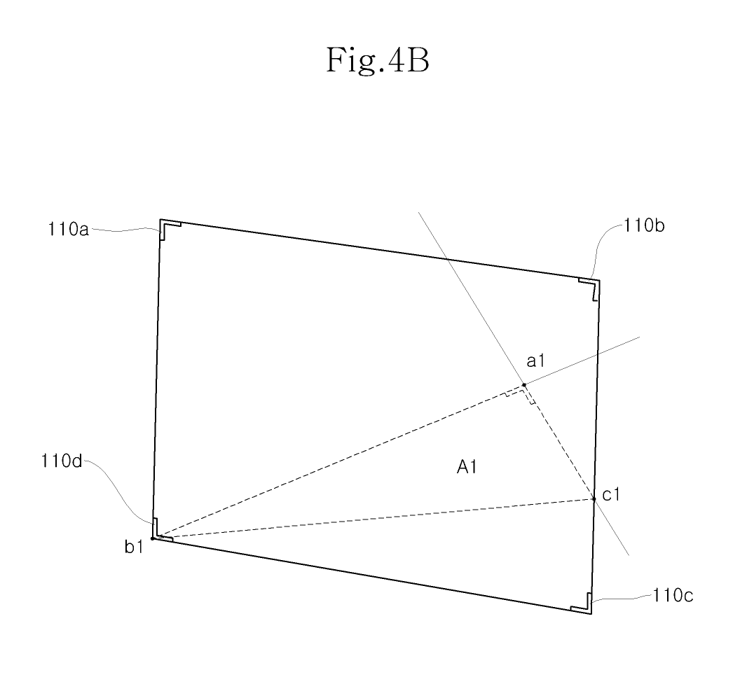

FIG. 4a and FIG. 4b are diagrams illustrating a method for calculating an overlapping surface of a first screen and a second screen when a flexible display of FIG. 2 is folded at an angle according to an exemplary embodiment of the present invention.

Referring to FIG. 4a and FIG. 4b, when the flexible display 10 is folded at an angle, such that edges of the first screen and the second screen are not parallel to each other, the third signal input device 110c contacts or overlaps the first screen or the second screen, and the sensing unit 120 may detect the contact position or the overlapped position of the third signal input device 110c. Thus, a first coordinate a1, which may be a coordinate of the vertex of the third signal input device 110c, may be detected through the sensing unit 120. Although the first coordinate is described as corresponding to a vertex of a signal input device, aspects of the invention are not limited thereto, such that the first coordinate may correspond to a reference position of the signal input device, or various portions of the signal input device.

Since the coordinate information storage unit 132 may store the shape information of the third signal input device 110c in advance, the calculation unit 134 may calculate a first folding point coordinate b1, and a second folding point coordinate c1 of the point where the second screen is folded or bent, i.e., the folding portion, to overlap the first screen. More specifically, the folding point coordinates may be calculated by virtually extending an edge of the third signal input device 110c to intersect an edge of the first screen of the flexible display 10. The edges of the third signal input device 110c may be virtually extended in a straight line based on the shape information. Further, the calculation unit 134 may calculate an area A1 of the overlapping region of the first screen and the second screen, which may be an area formed by connecting the first coordinate a1, the first folding point coordinates b1, and the second folding point coordinate c1. A coordinate, such as the folding point coordinate, may refer to a particular point or position on the first screen or the second screen on the flexible display.

The coordinate converting unit 136 may provide an image that was displayed on an overlapped portion of the first screen on the folded second screen based on the information on the overlapping region of the first screen and the second screen calculated by the calculation unit 134, thereby displaying a continuous image.

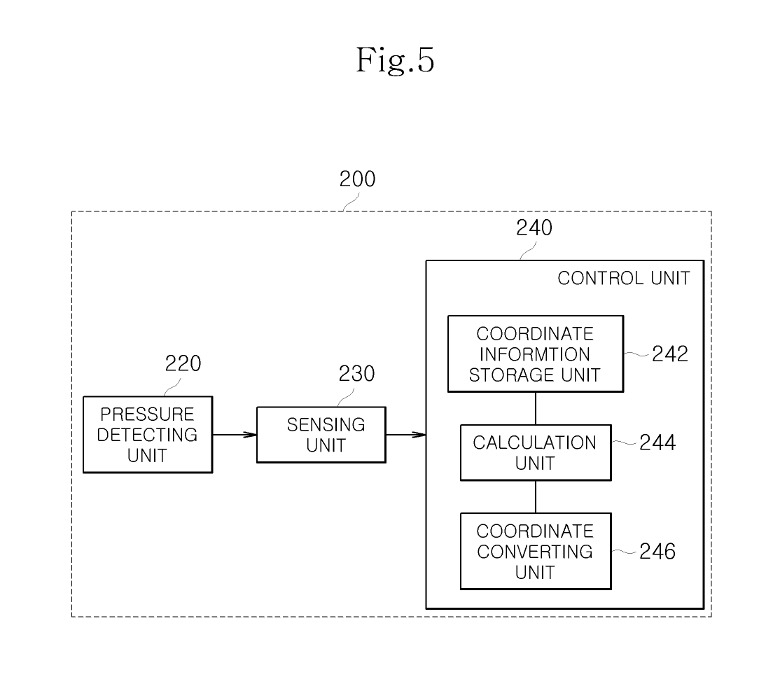

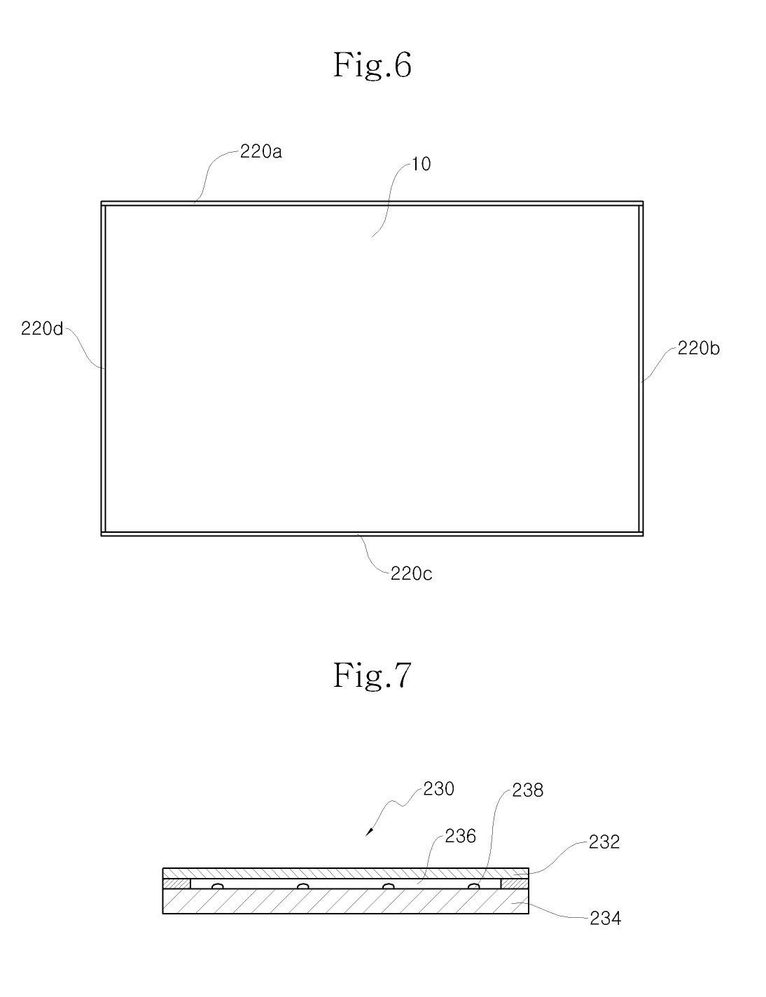

FIG. 5 is a schematic configuration diagram illustrating a terminal with a flexible display according to an exemplary embodiment of the present invention. FIG. 6 is a plan view illustrating the terminal of FIG. 5.

Referring to FIG. 5 and FIG. 6, a continuous screen providing device 200 includes a pressure detecting unit 220, a sensing unit 230, and a control unit 240. The pressure detecting unit 220 includes a first pressure detector 220a, a second pressure detector 220b, a third pressure detector 220c, and a fourth pressure detector 220d.

Multiple pressure detectors, including the first pressure detector 220a, the second pressure detector 220b, the third pressure detector 220c, and the fourth pressure detector 220d are installed along the edges of the flexible display 10. The respective pressure detectors may detect a change in a pressure applied to various positions or points along the respective edges. The configuration and the operation principle of the first pressure detector 220a, the second pressure detector 220b, the third pressure detector 220c, and the fourth pressure detector 220d will be described later in more detail.

The sensing unit 230 may detect a folded direction and the folded region of the flexible display 10 based on positions of where pressure is changed along at least one of the first pressure detector 220a, the second pressure detector 220b, the third pressure detector 220c, and the fourth pressure detector 220d.

The control unit 240 may calculate a region where the first screen and the second screen of the flexible display 10 overlap each other based on the folded direction and the folded region of the flexible display 10 detected by the sensing unit 230. The control unit 240 may allow coordinates of the first screen and the second screen to be mapped to each other in the overlapping region, such that a continuous image may be displayed on the first screen and the second screen when the first screen is folded.

The control unit 240 includes a coordinate information storage unit 242, a calculation unit 244, and a coordinate converting unit 246.

The coordinate information storage unit 242 may store positional coordinate value of one or more pixels displayed on at least one of the first screen and the second screen of the flexible display 10. As the coordinate information storage unit 242, an external storage device, which may semi-permanently store data, or a nonvolatile memory, such as a ROM/NAND flash memory may be used.

The calculation unit 244 calculates the overlapping region of the first screen and the second screen based on changes in the pressure along various positions of at least one of the first pressure detector 220a, the second pressure detector 220b, the third pressure detector 220c, and the fourth pressure detector 220d.

The coordinate converting unit 246 may allow coordinates of the first screen and the second screen to be mapped to each other in the overlapping region of the first screen and the second screen. More specifically, the coordinate converting unit 246 may allow coordinates of the first screen and the second screen to be mapped to each other in the overlapping region of the first screen and the second screen based on the positional coordinate values of the first screen and the second screen stored in the coordinate information storage unit 242 and the overlapping region information of the first screen and the second screen calculated by the calculation unit 244. Accordingly, an image displayed on a partial region of the first screen, which may be physically covered by the second screen may be seen through the second screen.

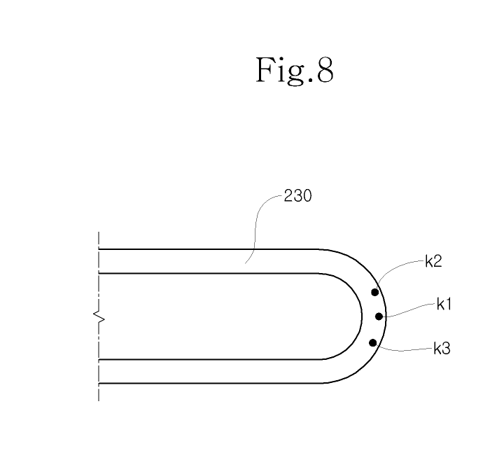

FIG. 7 is a cross-sectional view illustrating a pressure detector of FIG. 6. FIG. 8 is a diagram illustrating detection of a bending degree according to deformation of a flexible display according to an exemplary embodiment of the present invention.

Referring to FIG. 7, the pressure detecting unit 220 includes an upper plate 232 and a lower plate 234, which may be formed of an indium tin oxide (ITO) film, and an adhesive layer 236 with a space to accommodate a plurality of signal detecting dots 238, which protrude from an upper surface of the lower plate 234. When physical pressure is applied to the pressure detecting unit 220, the upper plate 232 may become bent so that the signal detecting dot 238 may detect a change in the electrical state of the overlapped position between the upper plate 232 and the lower plate 234. Accordingly, the pressure detecting unit 220 may output a change in the pressure as electrical signals. In an example, the pressure detecting unit 220 may be disposed along the edges of the first and/or second screen.

Referring to FIG. 8, when a physical deformation is applied to the pressure detecting unit 220, amount of the electrical change at position k1 may be greater than or equal to a reference threshold, and the electrical change amounts at a position k2 and a position k3 may is be smaller than that of the position k1 and below the reference threshold. The position where the amount of electrical change is greater than or equal to the reference threshold may be determined as a folding point, or a location where the first screen is folded. Thus, when the flexible display 10 is folded, the pressure detector 220 may detect a position with the electrical change amount greater than or equal to the reference threshold as the folding point.

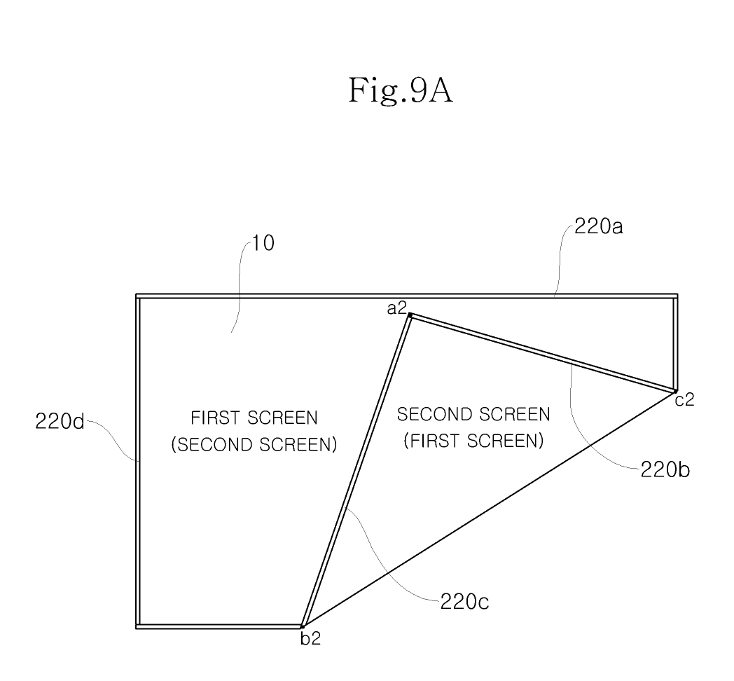

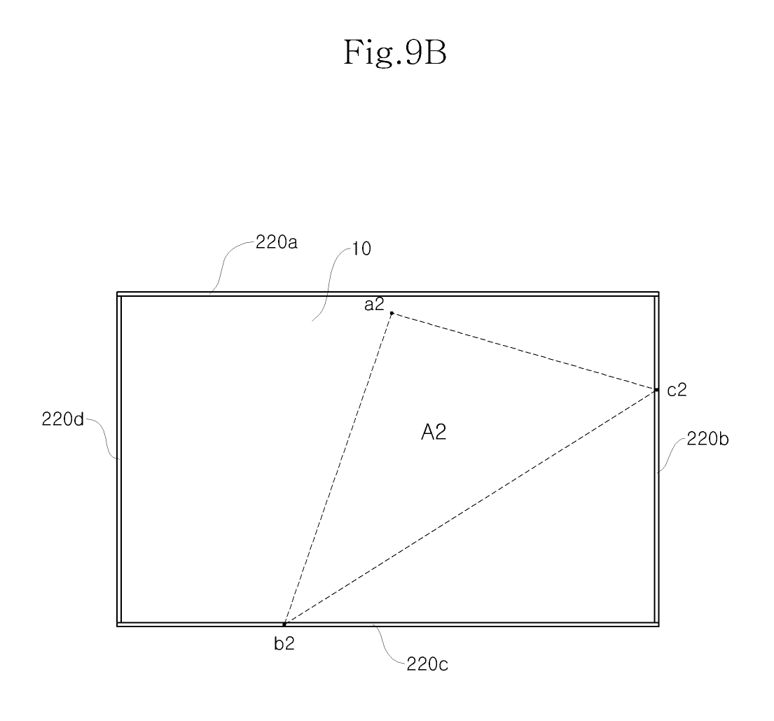

FIG. 9a and FIG. 9b are diagrams illustrating a method for calculating an overlapping surface of a first screen and a second screen when a flexible display of FIG. 6 is folded at an arbitrary angle according to an exemplary embodiment of the present invention.

Referring to FIG. 9a and FIG. 9b, when the flexible display 10 is folded at an angle such that edges of the first screen and the second screen are not parallel to each other, the second pressure detector 220b and the third pressure detector 220c may detect a change in the pressure applied to a first folding position b2 and a second folding position c2 along the edges of the flexible display 10. Accordingly, the sensing unit 230 may detect that a certain region of the flexible display 10 is folded along a line connecting the folding position b2 and the folding position c2 such that the overlapping portion of the second screen overlaps over the first screen. Further, a folding direction of the fold may be determined based on the pressure change positions of each edge detected by the second pressure detector 220b and the third pressure detector 220c.

Further, the calculation unit 244 may calculate a position and an area A2 size of the overlapping region of the first screen and the second screen by connecting the overlapping position or point a2 of the vertex and the first folding position or point b2 and the second folding position or point c2 based on the folding direction and the folding region of the flexible display 10 detected by the sensing unit 230.

The coordinate converting unit 246 allows an image displayed on the first screen is or the second screen to be continuously displayed on the folded portion of the screen based on the overlapping region information of the first screen and the second screen calculated by the calculation section 244.

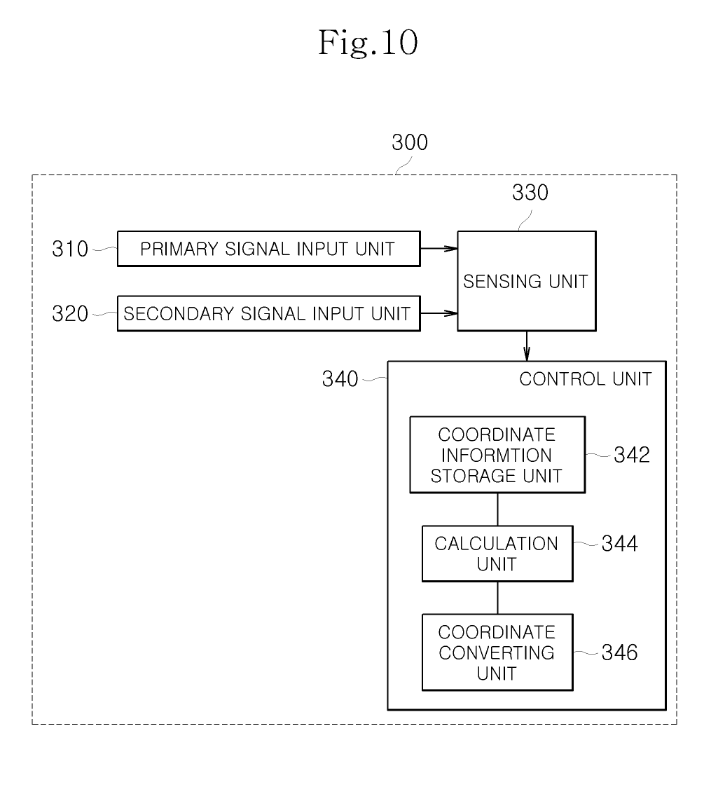

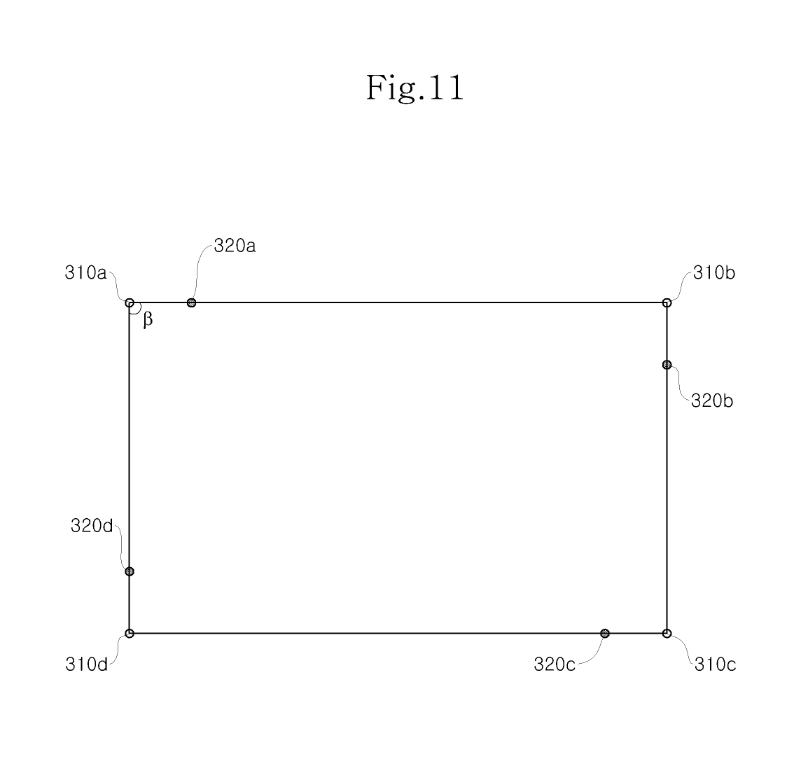

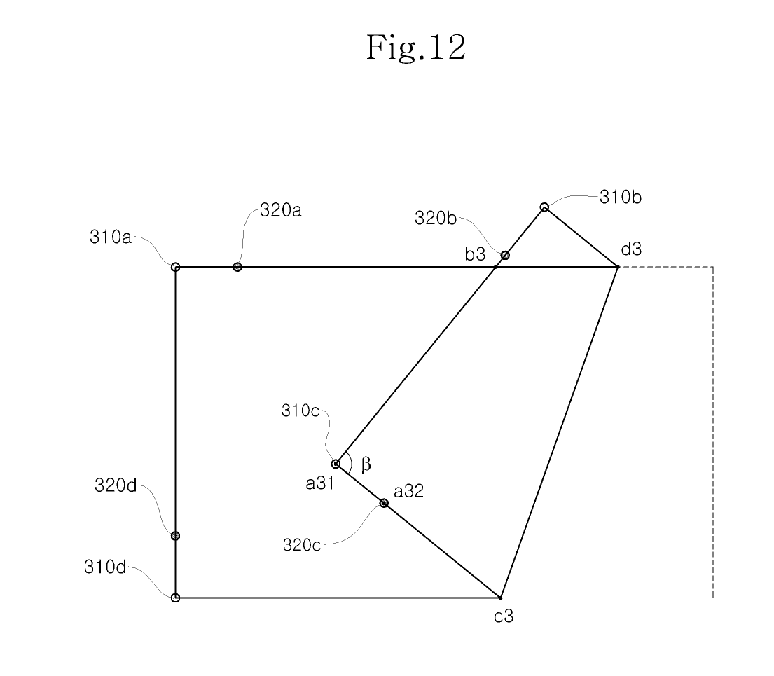

FIG. 10 is a schematic configuration diagram illustrating a terminal with a flexible display according to an exemplary embodiment of the present invention. FIG. 11 is a plan view illustrating the terminal of FIG. 10.

Referring to FIG. 10 and FIG. 11, a flexible terminal 300 includes a primary signal input unit 310, a secondary signal input unit 320, a sensing unit 330, and a control unit 340.

The primary signal input unit 310 includes a first primary signal input device 310a, a second primary signal input device 310b, a third primary signal input device 310c, and a fourth primary signal input device 310d, which are installed at the respective vertexes of the outer edges of the flexible display 10. The secondary signal input unit 320 includes a first secondary signal input device 320a, a second secondary signal input device 320b, a third secondary signal input device 320c, and a fourth secondary signal input device 320d, which are installed at arbitrary positions along an edge extending from the vertexes where the first primary signal input device 310a, the second primary signal input device 310b, the third primary signal input device 310c, and the fourth primary signal input device 310d are positioned.

The sensing unit 330 may detect a position of at least one of the first primary signal input device 310a, the second primary signal input device 310b, the third primary signal input device 310c, and the fourth primary signal input device 310d. Further, the sensing unit 330 may detect where the secondary signal input unit 320 contacts or overlaps the first screen of the flexible display 10. In order to distinguish the contact positions or the overlapping positions of the primary signal input device 310 and the secondary signal input device 320, the primary signal input device 310 and the secondary signal input device 320 may be formed of conductors with different dielectric constants. Accordingly, a first electrical signal caused by the contact or overlap of the primary signal input device 310 and a second electrical signal caused by the contact or overlap of the second signal input device 320 detected by the sensing unit 330 may be distinguished from each other.

The control unit 340 may calculate a region where a portion of the second screen overlaps over the first screen based on the position values detected by the sensing unit 330. Further, the control unit 340 may allow the coordinate of the first screen to be mapped to the coordinate of second screen in the overlapping region, such that an image that was displayed on the first screen before a folding operation may be continuously displayed on the first screen and the overlapping second screen.

Referring to FIG. 10, the control unit 340 includes a coordinate information storage unit 342, a calculation unit 344, and a coordinate converting unit 346. In an example, the coordinate information storage unit 342, the calculation unit 344, and the coordinate converting unit 346 may be integrated as a single unit.

The coordinate information storage unit 342 may store the positional coordinate value of each pixel forming the first screen and the second screen of the flexible display 10, the corresponding positional relationship information of the primary signal input unit 310 and the secondary signal input unit 320, and information on a corner angle β of the flexible display 10.

The calculation unit 344 may calculate the overlapping region of the first screen and the second screen based on the position values of at least one of the primary signal input unit 310 and the secondary signal input unit 320 detected by the sensing unit 330.

The coordinate converting unit 346 may allow the coordinate of the first screen to be mapped to the coordinate of second screen in the overlapping region based on the positional coordinate values of the first screen and the second screen stored in the coordinate information storage unit 342 and the overlapping region information of the first screen and the second screen calculated by the calculation unit 344. Accordingly, an image displayed in a partial region of the first screen, which may be physically covered by the second screen, may be seen on the second screen.

FIG. 12 is a diagram illustrating a method for calculating an overlapping surface of a first screen and a second screen when a flexible display of FIG. 11 is folded at an angle according to an exemplary embodiment of the present invention.

Referring to FIG. 12, when the flexible display 10 is folded at an angle, the third primary signal input device 310c and the third secondary signal input device 320c contact or overlap the first screen, and the sensing unit 330 detects the contact position values or overlapped position values of the third primary signal input device 310c and the third secondary signal input device 320c. Thus, a first overlapping coordinate a31, a second overlapping coordinate a32 of the contact or overlapped positions of the third primary signal input device 310c and the third secondary signal input device 320c may be detected through the sensing unit 330.

Further, the calculation section 344 may calculate an intersecting coordinate value b3 and a second folding point c3, where a first virtual line connecting the first overlapping coordinate a31 and the second overlapping coordinate a32 corresponding to overlapping positions of the third primary signal input device 310c and the third secondary signal input device 320c, and a second virtual line forming an angle β with respect to the first virtual line intersect the outer edges of the flexible display 10. The intersecting positions may be determined by using positional relationship information of the primary signal input unit 310 and the secondary signal input unit 320 stored in the coordinate information storage unit 342 and the information on the corner angle β of the flexible display 10.

More specifically, the calculation unit 344 may calculate the second folding coordinate c3 corresponding to a point where the first virtual line connecting a first overlapping coordinate a31 to a second overlapping coordinate a32 extends to intersect a lower edge of the flexible display 10. The second folding coordinate c3 may be determined by using the positional relationship information of the primary signal input device 310 and the secondary signal input unit 320 stored in the coordinate information storage unit 342. The first overlapping coordinate a31 may correspond to the third primary signal input device 310c. The second overlapping coordinate a32 may correspond to the third secondary signal input device 320c.

Further, the calculation unit 344 may calculate an intersecting coordinate b3, which may be a point of intersection between a second virtual line extending at a reference angle β from the first virtual line. More specifically, the second virtual line may extend to intersect an upper edge of the flexible display 10 at the intersecting coordinate b3. However, aspects of the invention are not limited thereto, such that the intersecting coordinate b3 may be determined by a signal processing device installed along an edge of the second screen, which may illicit a change in the electrical current when the respective edge of the second screen overlaps an edge of the first screen.

Further, the calculation section 344 may calculate or derive a second folding coordinate d3 based on the information on at least one of the first overlapping coordinate a31, the second overlapping coordinate a32, the intersecting coordinate b3, and the first folding coordinate c3 and the geometric information of the flexible display 10. The calculation section 344 may also calculate the position and the area of the overlapping region of the first screen and the second screen using at least one of the first overlapping coordinate a31, the second overlapping coordinate a32, the intersecting coordinate b3, the first folding coordinate c3, and the second folding coordinate d3.

The coordinate converting unit 346 may provide an image of a covered portion of the first screen on the folded second screen based on the overlapping region information of the first screen and the second screen calculated by the calculation unit 344 to continuously provide an image even when the flexible display 10 is folded.

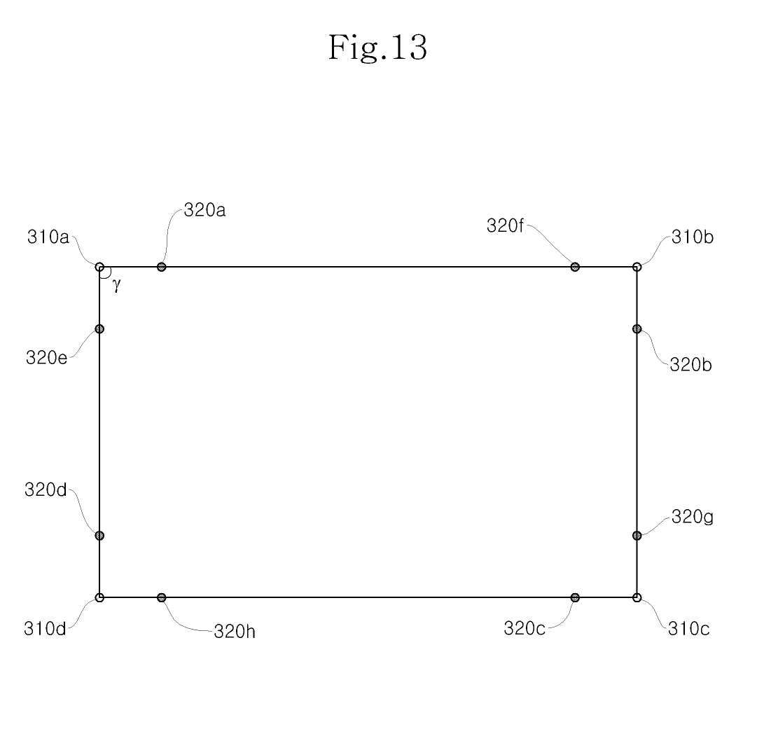

FIG. 13 is a plan view illustrating a flexible display of FIG. 10.

Referring to FIG. 13, in a flexible display 300 of FIG. 11, a plurality of secondary signal input devices, including a first secondary signal input device 320a, a second secondary signal input device 320b, a third secondary signal input device 320c, and a fourth secondary signal input device 320d, a fifth secondary signal input device 320e, a sixth secondary signal input device 320f, a seventh secondary signal input device 320g, and an eighth secondary signal input device 320h are installed at arbitrary positions of one of two edges extending from the vertexes or corners of the flexible display 300. A plurality of primary signal input devices, including a first primary signal input device 310a, a second primary signal input device 310b, a third primary signal input device 310c, and a fourth primary signal input device 310d are positioned at the vertexes or corners of the flexible display 300. More specifically, the plurality of secondary signal input devices, including the first secondary signal input device 320a, the second secondary signal input device 320b, the third secondary signal input device 320c, the fourth secondary signal input device 320d, the fifth secondary signal input device 320e, the sixth secondary signal input device 320f, the seventh secondary signal input device 320g, and the secondary eighth signal input device 320h of FIG. 13 are respectively installed at two edges extending from the vertexes or corners of the flexible display 300 where the plurality of primary signal input devices, including the first primary signal input device 310a, the second primary signal input device 310b, the third primary signal input device 310c, and the fourth primary signal input device 310d are positioned.

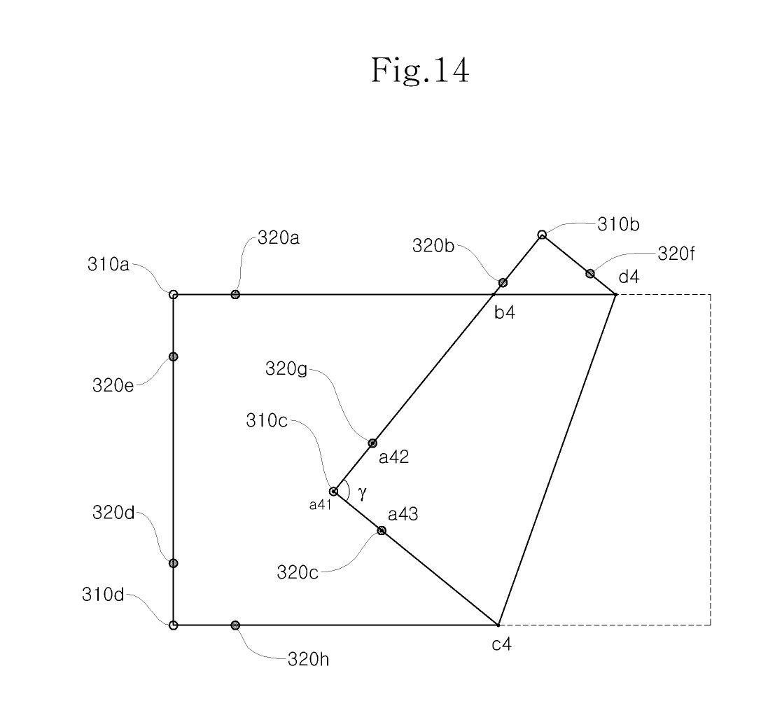

FIG. 14 is a diagram illustrating a method for calculating an overlapping surface of a first screen and a second screen when a flexible display of FIG. 13 is folded at an angle according to an exemplary embodiment of the present invention.

Referring to FIG. 14, when the flexible display 10 is folded at an angle, the third primary signal input device 310c, the third secondary signal input device 320c, and the seventh secondary signal input device 320g contact or overlap the first screen, and the sensing unit 330 detects the contact or overlapped position values of the third primary signal input device 310c, the third secondary signal input device 320c, and the seventh secondary signal input device 320g. Thus, the first overlapping coordinate a41, the second overlapping coordinate a42, and the third overlapping coordinate a43 of the contact or overlapped positions of the third primary signal input device 310c, the third secondary signal input device 320c, and the seventh secondary signal input device 320g are detected through the sensing unit 330.

Further, the calculation unit 344 may calculate an intersecting coordinate b4 corresponding to an intersection of an edge of the second screen with an edge of the first screen. More specifically, referring to FIG. 14, a portion of the first screen is folded at a second folding coordinate d4 and flipped over to overlap the unfolded portion of the first screen to display a portion of the second screen. An edge of the second screen, which includes the first overlapping coordinate a41 and the second overlapping coordinate a42 corresponding to the contact or overlapping positions of the third primary signal input device 310c and the seventh secondary signal input device 320g, intersects an upper edge of the first screen, which includes the first primary signal input device 310a and the first secondary signal input device 320a, at the intersecting coordinate b4.

The calculation unit 344 may also calculate a first folding coordinate c4 corresponding to a point of fold, where a portion of the first screen is folded and flipped over to overlap the unfolded portion of the first screen to display a portion of the second screen. More specifically, an edge of the second screen, which includes the first overlapping coordinate a41 and the third overlapping coordinate a43 corresponding to the contact or overlapped positions of the third primary signal input device 310c and the third secondary signal input device 320c, intersects a lower edges of the first screen, which includes the fourth primary signal input device 310d and the eighth secondary signal input device 320h, at the intersecting coordinate c4.

The calculation unit 344 may calculate the intersecting coordinate b4 and the first folding coordinate c4 using mutual positional relationship information of the primary signal input unit 310 and the secondary signal input unit 320 stored in the coordinate information storage section 342. Further, the calculation unit 344 may derive the second folding coordinate d4 based on the information on the values of the first overlapping coordinate a41, the second overlapping coordinate a42, the third overlapping coordinate a43, the intersecting coordinate b4, the first folding coordinate c4, and geometric information including a corner angle γ, which is provided between an edge including the seventh secondary signal input device 320b and the second secondary signal input device 320b and an edge including the third secondary signal input device 320c, of the flexible display 10. Further, the calculation unit 344 may calculate the position and the area of the overlapping region of the first screen and the second screen using the first overlapping coordinate a41, the second overlapping coordinate a42, the third overlapping coordinate a43, the intersecting coordinate b4, the first folding coordinate c4, and the second intersecting coordinate d4.

The coordinate converting unit 346 may provide an image of a covered portion of the first screen to the folded portion of the first screen or the second screen based on the information on the overlapping region of the first screen and the second screen calculated by the calculation unit 344, thereby continuously providing the image.

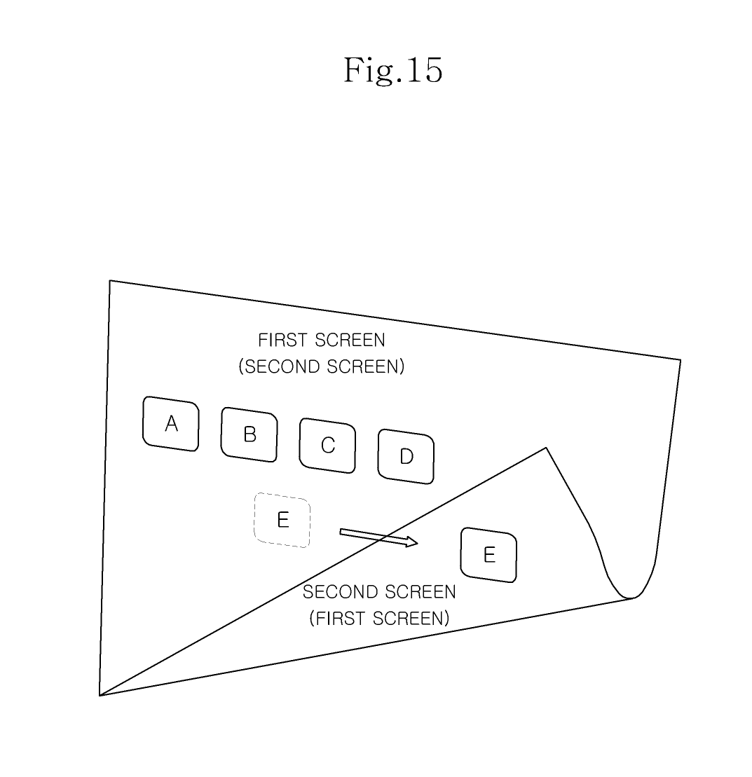

FIG. 15 is a diagram illustrating a movement of an image from a first screen to a second screen on a flexible display according to an exemplary embodiment of the present invention.

Referring to FIG. 15, the flexible display 10 may not only continuously display the image displayed on the first screen on the second screen, but may also allow an operation of moving an icon from the first screen to the second screen in a manner such that the icon displayed on the first screen is dragged or flicked by the user.

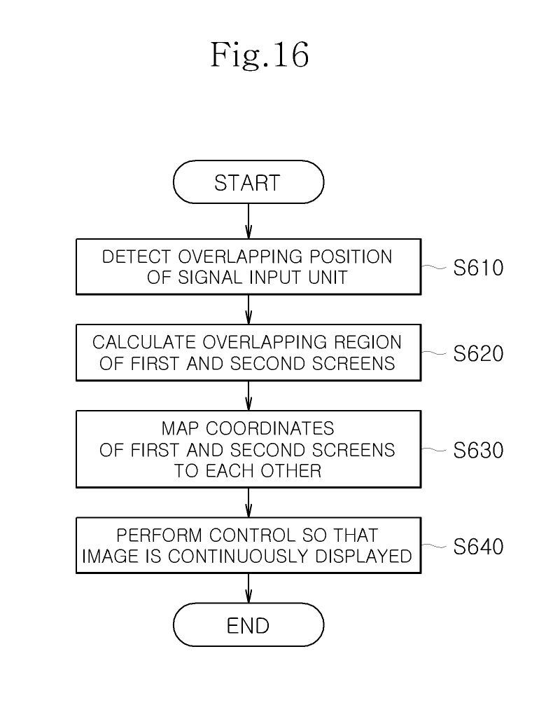

FIG. 16 is a flowchart illustrating a method for providing a continuous screen on a flexible display according to an exemplary embodiment of the present invention.

Referring to FIG. 16, in operation S610, a sensing unit detects positions of one or more signal input units contacting or overlapping at least one of the first screen or second screen of a flexible display. A signal input device may be disposed in a region where vertex of the edges of the flexible display or corners of the flexible display is positioned.

Further, according to aspects of the invention, the signal input units may include a primary signal input device and a secondary signal input device. The primary signal input unit may be installed at one or more vertexes of the outer edges of the flexible display 10, and the second signal input unit may be installed at an arbitrary position along one or more edges extending from the vertexes where the primary signal input unit is positioned.

In operation S620, a control unit calculates the overlapping region of the first screen and the second screen of the flexible display based on the position information or values detected by the sensing unit. In operation S630, the control unit allows the coordinates of the first screen and the second screen to be mapped to each other inside the overlapping region of the first screen and the second screen.

In operation S640, the control unit performs a control so that a portion of the image that was displayed on the first screen before the fold is displayed on the second screen after the fold to provide a continuous image displayed. More specifically, the portion of the image displayed on the first screen that becomes overlapped by the second screen may be displayed on the overlapping second screen.

In order to perform operation S620, operation S630, and operation S640, the control unit may include a coordinate information storage unit, a calculation unit, and a coordinate converting unit.

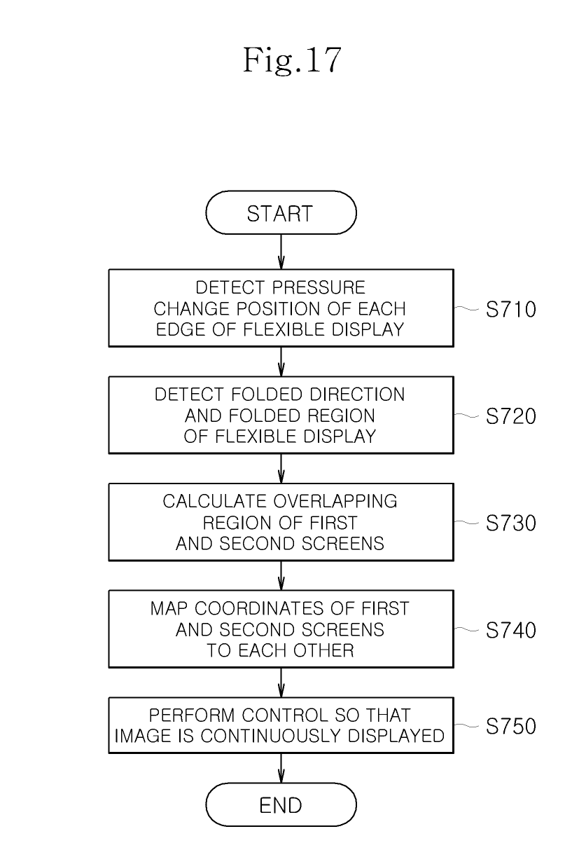

FIG. 17 is a flowchart illustrating a method for providing a continuous screen of a flexible display according to an exemplary embodiment of the present invention.

Referring to FIG. 17, in operation S710, a pressure detecting unit, which may be installed at one or more edges of the flexible display, detects a change in the pressure applied to an arbitrary position one or more edges of the flexible display.

In operation S720, the sensing unit 230 detects a folding direction and a folding region of the flexible display based on the pressure change positions detected by the pressure detecting unit.

In operation S730, the control unit calculates an overlapping region of the first screen and the second screen of the flexible display based on the position values detected by the sensing unit. In operation S740, the control unit allows the coordinates of the first screen and the second screen to be mapped to each other inside the overlapping region of the first screen and the second screen.

In operation S750, the control unit performs a control so that a portion of the image displayed on the first screen before the fold is displayed on the second screen after the fold to provide a continuous image displayed. More specifically, the portion of the image displayed on the first screen that becomes overlapped by the second screen may be displayed on the overlapping second screen.

In order to perform operation S730, operation S740, and operation S750, the control unit may include a coordinate information storage unit, a calculation unit, and a coordinate converting unit.

Since the flexible display according to exemplary embodiments of the present invention allows the image displayed on the first screen to be continuously displayed on the overlapping second screen when the flexible display is folded, a user may use the flexible display with more versatility.

Although a portion of the second screen is described as being folded over a portion of the first screen, aspects of the invention are not limited thereto, such that the portion of the second screen may be rolled, flipped, bent, or adjusted to overlap the portion of the first screen.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for continuously displaying an image on a flexible display, comprising:
displaying an image on a first screen of the flexible display, the flexible display comprising the first screen and a second screen;
determining whether the first screen is overlapped by the second screen;
calculating an overlapping region of the second screen when the first screen is overlapped by the second screen, the overlapping region of the second screen overlapping at least a portion of the first screen;
mapping coordinates of the first screen with the second screen for the overlapping region; and
displaying at least a portion of the image displayed on the first screen on the overlapping region of the second screen based on the mapped coordinates.

2. The method of claim 1, further comprising:
detecting an overlapping point of the second screen over the first screen,
wherein the calculating of the overlapping region of the second screen is based on the detected overlapping point.

3. The method of claim 1, further comprising:
calculating an overlapped region of the first screen, the overlapped region of the first screen being overlapped by at least a portion of the second screen.
wherein the displaying further comprises displaying at least a portion of the image displayed on the overlapped region of the first screen on the overlapping region of the second screen.

4. The method of claim 2, wherein the overlapping point is detected by at least a primary signal input unit and a secondary signal input unit.

5. The method of claim 1, further comprising:
detecting a change in pressure along an edge of the flexible display; and
determining a folding point of the flexible display based on a position of the detected change in pressure.

6. The method of claim 5, further comprising:
calculating an intersecting point between an edge of the second screen and an edge of the first screen using at least one of a detected overlapping point of the second screen over the first screen, the folding point, and a reference angle formed between two adjacent edges of the second screen.

7. The method of claim 6, wherein the overlapping region is calculated using at least one of the detected overlapping point, the folding point, and the intersecting point.

8. The method of claim 1, further comprising:
calculating coordinates of the overlapping region of the first screen and the second screen using position relationship information of a primary signal input unit and a secondary signal input unit.

9. A terminal, comprising:
a flexible display comprising a first screen and a second screen on which images are displayed, the first screen and second screen being disposed on opposite sides of the flexible display; and
a control unit to determine whether the first screen is overlapped by the second screen, to calculate an overlapping region of the second screen when the first screen is overlapped by the second screen, to map coordinates of the first screen to the second screen with respect to the overlapping region, and to display a portion of the image on the second screen,
wherein the overlapping region of the second screen overlaps at least a portion of the first screen.

10. The terminal of claim 9, further comprising:
a signal input unit comprising a plurality of signal input devices to detect an overlapping point of the second screen over the first screen; and
a sensing unit to detect a position of at least one of the signal input device, the signal input devices being disposed at edges of the flexible display,
wherein the control unit calculates the overlapping region of the second screen based on the detected overlapping point.

11. The terminal of claim 9, wherein the control unit calculates an overlapped region of the first screen, the overlapped region of the first screen being overlapped by at least a portion of the second screen, and
wherein the control unit displays at least a portion of the image displayed on the overlapped region of the first screen on the overlapping region of the second screen.

12. The terminal of claim 10, wherein the signal input unit comprises a primary signal input unit and a secondary signal input unit, the primary signal input unit comprising a plurality of primary signal input devices and the secondary signal input unit comprises a plurality of secondary signal input devices.

13. The terminal of claim 12, wherein at least one of the primary signal input devices is disposed at a corner of the flexible display unit and at least one of the secondary signal input units is disposed along an edge of the flexible display between the corners.

14. The terminal of claim 12, wherein at least one of the secondary signal input devices detects a folding point when an electrical change detected by the secondary signal input device is above a reference threshold.

15. The terminal of claim 14, wherein the control unit calculates an intersecting point between an edge of the first screen and an edge of the second screen using at least one of the overlapping point, the folding point, and a reference angle formed between two adjacent edges of the second screen.

16. The terminal of claim 9, further comprising:
a coordinate information storage unit to store coordinates of the first screen and coordinates of the second screen.

17. The terminal of claim 16, wherein the control unit maps coordinates of the second screen using the coordinates of the first screen and the second screen stored in the coordinate information storage unit.

18. The terminal of claim 12, wherein at least one of the secondary signal input units is a pressure detector to detect a change in pressure applied to at least one of the pressure detectors.

19. A terminal, comprising:
a flexible display comprising a first screen and a second screen to display an image on the first screen;
a pressure detecting unit comprising a plurality of pressure detectors to detect a change in pressure applied to at least one of the pressure detectors;
a sensing unit to determine a folded direction and a folded region of the flexible display based on the detected change in pressure; and
a control unit to calculate a region where the first screen and the second screen overlap based on the folded direction and the folded region, to map coordinates of the overlapped first screen to the second screen, and to display a portion of the image on the second screen.

20. The terminal of claim 19, wherein the control unit calculates the region where the first screen and the second screen overlap based on the detected changes in pressure.
